(19) United States
(12) Patent Application Publication
(10) Pub. No.: US 2024/0275086 A1
(43) Pub. Date: Aug. 15, 2024

(54) Breaker Box Power Transfer Extension Cord System

(71) Applicant: Billy Bryant, Vicksburg, MS (US)

(72) Inventor: Billy Bryant, Vicksburg, MS (US)

(21) Appl. No.: 18/406,309

(22) Filed: Jan. 8, 2024

Related U.S. Application Data
(60) Provisional application No. 63/445,480, filed on Feb. 14, 2023.

(51) Int. Cl. H01R 11/24

(52) U.S. Cl. CPC H01R 11/24; H01B 7/361

(57) ABSTRACT

An extension cord system designed for the safe and efficient transfer of electrical power from a conventional main breaker box to a power source, such as a generator, thereby providing electrical power for worksites and buildings without requiring electrical hookups. The extension cord system comprises a main wire with integrated split wires at one end and a three-prong plug at the other end, providing compatibility with standard electrical configurations. The split wires include a hot wire with alligator or electrical clips for secure connection to the breaker box's hot bar(s), a neutral wire with an alligator or electrical clip attached to the neutral bar, and a ground wire with an alligator or electrical clip for grounding to the ground bar. The three-prong plug is plugged into the generator for enabling users to run lights and equipment using the generator.

### CROSS-REFERENCE TO RELATED APPLICATION

The present application claims priority to, and the benefit of, U.S. Provisional Application No. 63/445,480, which was filed on Feb. 14, 2023, and is incorporated herein by reference in its entirety.

### FIELD OF THE INVENTION

The present invention generally relates to the field of extension cords. More specifically, the present invention relates to a novel extension cord system that has three split wires at one end for connection to a main breaker box and a three-prong plug at another opposing end for connecting to a generator. The electrical power from the breaker box is transferred to the generator via the extension cord. Alligator or electrical clips are attached to the split wires for clipping to the breaker box. Accordingly, the present disclosure makes specific reference thereto. Nonetheless, it is to be appreciated that aspects of the present invention are also equally applicable to other like applications, devices, and methods of manufacture.

### BACKGROUND

By way of background, many worksites and buildings that are under construction often lack proper electrical hookups. Electrical hookups may not be available due to a lack of internal electrical wiring from the main box or due to the walls being under construction. Due to a lack of electrical hookups, a reliable source of electricity is not available on-site. When electricity is not readily available, operators and workers at such sites may face significant challenges and are unable to use various power tools and equipment that require electricity to function effectively. Since power tools are essential for many construction tasks, the inability to use them can lead to delays in completing the work. Further, the issue extends beyond worksites. Even in many completed buildings, there may be a lack of electrical outlets or hookups. The individuals who travel and need access to electricity in a building might face difficulties.

To address such issues, individuals generally use auxiliary power sources which can be costly. Many such power sources run on fossil fuels which are not good for the environment. Further, in high-rise buildings, the availability of such bulky power sources is difficult and not always possible. Devices for easily receiving power from existing breaker boxes are not available for operating power tools. Individuals desire a device that can be used for providing quick and efficient electrical power to their tools and equipment on a worksite or in a building that does not have electricity hookups.

Therefore, there exists a long-felt need in the art for a device that enables users to access electricity in places where traditional electrical hookups are unavailable. Additionally, there is a long-felt need in the art for an electrical cord system that enables users to supply power from the main breaker box of a building. Moreover, there is a long-felt need in the art for an electrical device that supplies power from a main breaker box to a generator. Further, there is a long-felt need in the art for an extension cord system that improves the productivity of operators on a worksite by providing electricity from a main breaker box. Furthermore, there is a long-felt need in the art for an extension cord system that can be clipped to a main breaker box using integrated alligator-style clips. Finally, there is a long-felt need in the art for an extension cord system that saves time and effort of individuals when on a worksite by providing electricity from a main breaker box to a generator.

The subject matter disclosed and claimed herein, in one embodiment thereof, comprises an extension cord system used at worksites and buildings where electrical hookups are not available. The extension cord system is used for the safe and convenient transfer of electrical power between a main breaker box and a power source such as a generator for power tools. The extension cord system features a flexible main wire, the main wire having a first end and an opposite second end, three split wires extending out of the first end of the main wire, and a three-prong plug is integrated into the second end of the main wire. The three split wires include a hot wire having two alligator or electrical clips attached to the free end of the hot wire, a neutral wire having an alligator or electrical clip attached to the free end of the neutral wire, and a ground wire having an alligator or electrical clip attached to the free end of the neutral wire. The alligator or electrical clips are clipped to the main breaker box and the three-prong plug is connected to the generator for enabling electrical power to pass from the main breaker box to the generator.

In this manner, the extension cord system of the present invention accomplishes all of the foregoing objectives and provides users with an extension cord that utilizes alligator-style clips to supply power from a main breaker box to a generator. The system enables individuals to obtain power on a worksite or in a building that does not yet have electricity hookups. The system saves time and effort when on a worksite for those who have access to a generator by providing power for lights and equipment at a worksite.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an extension cord system for the safe and convenient transfer of electrical power from a main breaker box. The extension cord system comprises a main wire with an insulating layer enveloping the main wire, the main wire having a first end and a second end, three split wires extending out of the first end of the main wire, and a three-prong plug integrated into the second end of the main wire. The three split wires include a hot wire having two alligator or electrical clips attached to the free end of the hot wire, a neutral wire having an alligator or electrical clip attached to the free end of the neutral wire, and a ground wire having an alligator or electrical clip attached to the free end of the neutral wire.

In yet another embodiment, an extension cord system for providing electrical power from a main breaker box to a generator is disclosed. The system includes a main wire having a first end and a second end, three split wires integrated at the first end of the main wire, wherein the first split wire serves as a hot wire and is configured for connection to the hot bar of a main breaker box, the first split wire having two alligator or electrical clips attached at the free end thereof. The second split wire serves as a neutral wire and is designed for connection to a neutral bar of the main breaker box, the second split wire having one alligator or electrical clip attached at the free end thereof. The third split wire serves as a ground wire and is intended for connection to a ground bar of the main breaker box, the third split wire having one alligator or electrical clip attached at the free end of the third split wire. A three-prong plug at the second end of the main wire is configured for connection to a power source such as a generator, the three-prong plug accommodates standard electrical plug configurations used in buildings and generators, thereby enabling a complete electrical connection between the main breaker box and the power source.

In a further embodiment, a method for safely transferring electrical power using an extension cord system between a conventional breaker box and a generator is described. The method includes the steps of providing an extension cord system, the extension cord system includes a main wire having a first end and an opposite second end, three split wires integrated at the first end of the main wire, a three-prong plug at the second end of the main wire, placing the alligator type clips on the first split wire into female receivers of a hot bar of the conventional breaker box, thereby receiving electrical power from the conventional breaker box, clipping the alligator type clip of the second split wire to a neutral bar of the conventional breaker box, clipping the alligator type clip of the third split wire to a ground bar of the conventional breaker box, and connecting the three-prong plug to the generator for completing the electrical circuit. The method also includes connecting one or more power tools to the generator for receiving electrical power.

Numerous benefits and advantages of this invention will become apparent to those skilled in the art to which it pertains upon reading and understanding the following detailed specifications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the portable alligator or electrical clip extension cord system of the present invention in accordance with the disclosed structure;

FIG. 2 illustrates a perspective view showing clipping of the alligator type clips of the extension cord system of the present invention to the main breaker box in accordance with the disclosed architecture;

FIG. 3 illustrates a perspective view showing the use of the extension cord system of the present invention for providing power to a generator from the breaker box for activating the connected power tool in accordance with the disclosed architecture; and

FIG. 4 illustrates a flow chart depicting a process of using the extension cord system of the present invention for providing electrical power to power tools in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that enables users to access electricity in places where traditional electrical hookups are unavailable. Additionally, there is a long-felt need in the art for an electrical cord system that enables users to supply power from the main breaker box of a building. Moreover, there is a long-felt need in the art for an electrical device that supplies power from a main breaker box to a generator. Further, there is a long-felt need in the art for an extension cord system that improves the productivity of operators on a worksite by providing electricity from a main breaker box. Furthermore, there is a long-felt need in the art for an extension cord system that can be clipped to a main breaker box using integrated alligator-style clips. Finally, there is a long-felt need in the art for an extension cord system that saves time and effort of individuals when on a worksite by providing electricity from a main breaker box to a generator.

The present invention, in one exemplary embodiment, is a method for transferring electrical power using an extension cord system from a conventional breaker box to a generator. The method includes the steps of providing an extension cord system, the extension cord system includes three split wires, a three-prong plug; placing the alligator type clips on the first split wire into female receivers of a hot bar of the conventional breaker box, clipping the alligator type clip of the second split wire to a neutral bar of the conventional breaker box, clipping the alligator type clip of the third split wire to a ground bar of the conventional breaker box, and connecting the three-prong plug to the generator for completing the electrical circuit.

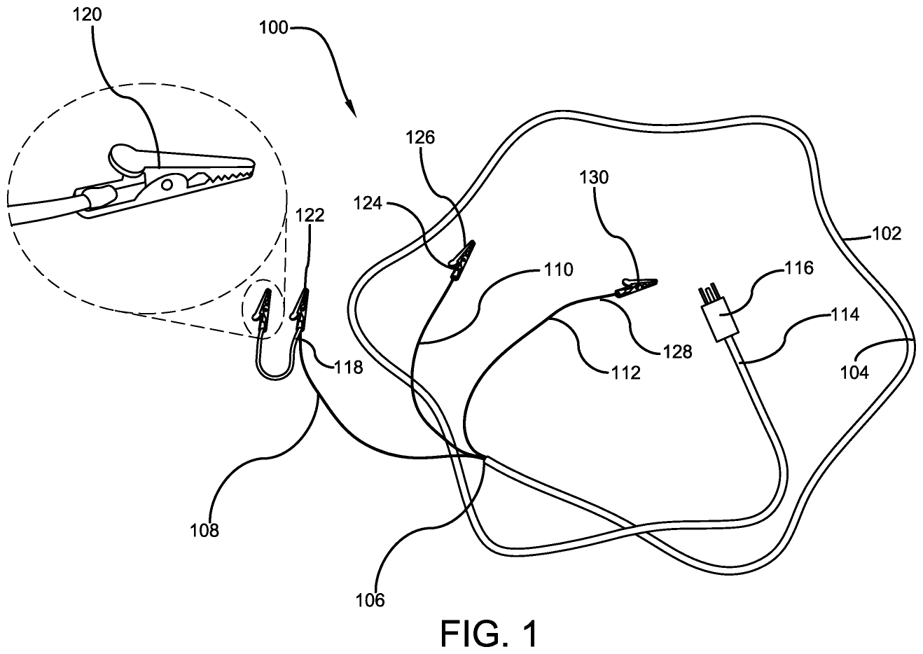

Referring initially to the drawings, FIG. 1 illustrates a perspective view of the portable alligator or electrical clip extension cord system of the present invention in accordance with the disclosed structure. The extension cord system 100 of the present invention is designed to be used for providing electrical power from a main breaker box of a building to a generator safely and conveniently. More specifically, the power transfer extension cord system 100 includes a main wire 102 having an insulating layer 104 disposed thereon to wrap the main wire 102. A first end 106 of the main wire 102 has integrated three split wires 108, 110, 112, and a second end 114 opposite to the first end 106 has a three-prong plug 116. The first split wire 108 is the conventional hot wire and can be color-coded as black or red. The second split wire 110 is the conventional neutral wire and can be color-coded as white or gray. The third split wire 112 is the conventional ground wire and can be color-coded as green or bare copper.

The free end 118 of the hot wire 108 has two alligator or electrical clips 120, 122. The alligator or electrical clips 120, 122 are clipped to the hot bar of a main breaker box for carrying electrical current from the main breaker box. The free end 124 of the neutral wire 110 has one alligator or electrical clip 126 and is designed to clip to the neutral bar of the main breaker box. The free end 128 of the ground wire 112 has one alligator or electrical clip 130 and is designed to clip to the ground bar of the main breaker box.

The three-prong plug 116 includes three prongs and is compatible with the standard electrical plug configuration used in buildings and generators. The plug 116 is designed to be connected to a power source such as a generator and enables a complete electrical connection between the main breaker box and the generator.

It will be apparent to a person skilled in the art that the alligator or electrical clips are used for making temporary electrical connections and can be of copper, nickel-plated steel, or any other corrosion free metal. The main wire 102 and the split wires 108, 110, 112 can be made of copper, aluminum, or steel. The extension cord system 100 can be designed to work with 12, 14, and 16 gauge wiring to meet different requirements of users. Further, the extension cord system 100 can work with circuits with amperage ratings between 15 and 20 amps.

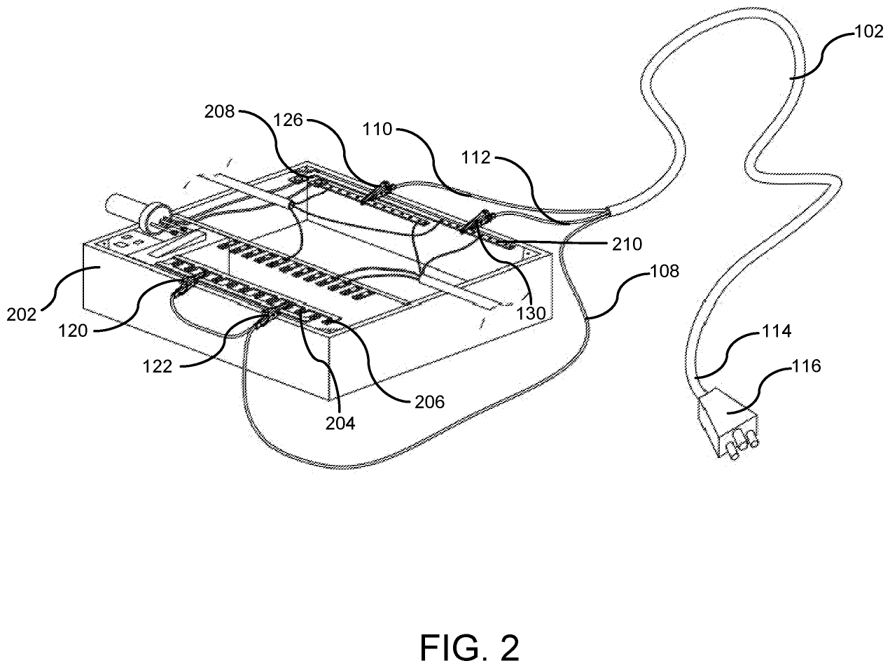

FIG. 2 illustrates a perspective view showing the clipping of the alligator type clips of the extension cord system 100 of the present invention to the main breaker box in accordance with the disclosed architecture. The main breaker box 202 shown in the present embodiment is the exemplary breaker box and any conventional breaker box can be used for clipping the extension cord system 100 of the present invention. As illustrated, the alligator type clips 120, 122 are clipped to female receivers 204 of the hot bar 206 of the breaker box 202 for receiving electrical power from the breaker box 202.

The alligator type clip 126 of the neutral wire 110 is clipped to the neutral bar 208 of the breaker box 202. Similarly, the alligator type clip 130 of the ground wire 112 is clipped to the ground bar 210 of the breaker box 202. The neutral wire 110 serves as a return path for the electrical current and helps complete the circuit and the ground wire 112 provides a safe path for electrical faults, such as a short circuit, to be safely conducted into the ground, preventing electrical shock and wire hazards.

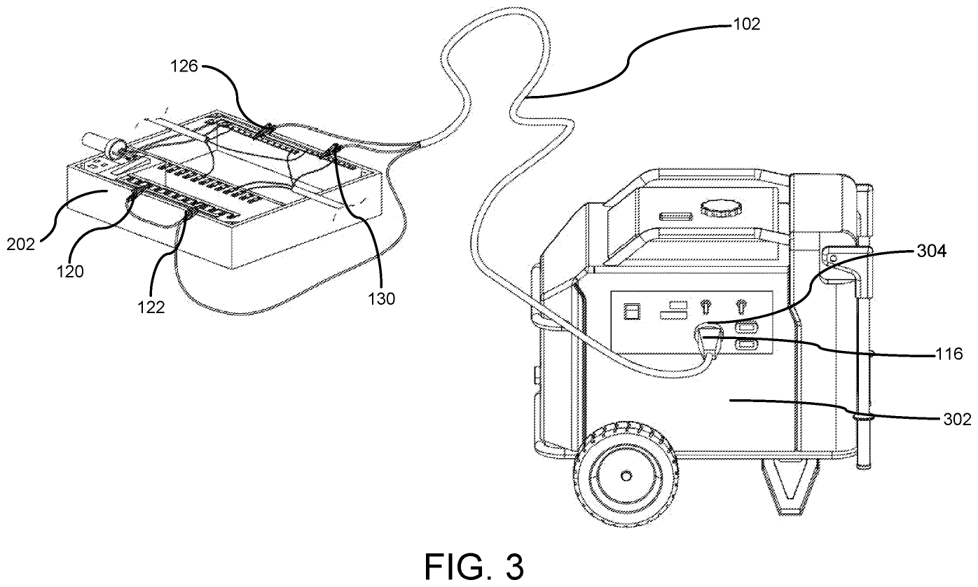

FIG. 3 illustrates a perspective view showing the use of an extension cord system of the present invention for providing power to a generator from the breaker box for activating the connected power tool in accordance with the disclosed architecture. As illustrated, the alligator type clips 120, 122, 126, 130 are clipped to the breaker box 202 as described in FIG. 2 and the three-prong plug 116 positioned at the opposite end 114 is connected to a female three-prong receiver 304 of a generator 302. The generator 302 can be used for providing electrical power for operating power tools at any work site.

The breaker box and generator connecting extension cord 100 can be used with different types of generators for providing electric power directly from the breaker box 202 without requiring any electrical hookups. Further, the extension cord system 100 can come in different lengths and amperage values to meet the requirements of different users.

The extension cord system 100 can also support multi-phase electrical systems commonly found in industrial settings. Further, the extension cord system 100 can have the safety sensor capability to detect electrical faults, such as ground faults or short circuits, and automatically disconnect power to prevent accidents or electrical wires.

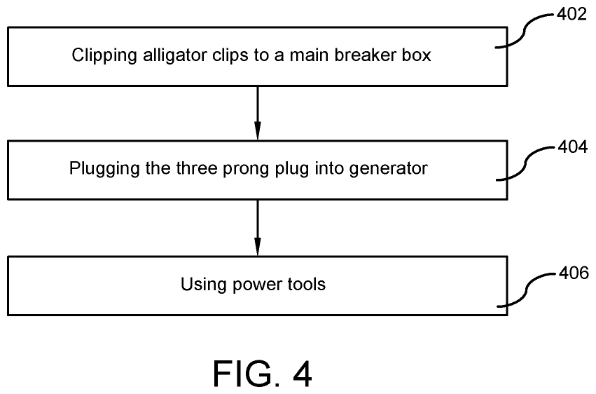

FIG. 4 illustrates a flow chart depicting a process of using the extension cord system of the present invention for providing electrical power to power tools in accordance with the disclosed architecture. Initially, the alligator or electrical clips connected to the 3-split wires of the extension cord are clipped to a main breaker box of a building (Step 402). The alligator or electrical clips function as male connectors and connect to the female receivers of the breaker box. Then, the three-prong plug of the extension cord 100 is plugged into the three-prong connector port of the generator (Step 404). As a result, the electrical circuit is complete between the breaker box and the generator. Finally, any conventional power tool is used with the power from the generator for working without requiring any electrical hookups (Step 406).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “breaker box and generator connecting extension cord”, “extension cord system”, “portable alligator or electrical clip extension cord system”, “power transfer extension cord system” and “extension cord” are interchangeable and refer to the multipurpose extension cord system 100 of the present invention.

Notwithstanding the foregoing, the multipurpose extension cord system 100 of the present invention can be of any suitable size and configuration as is known in the art without affecting the overall concept of the invention, provided that it accomplishes the above-stated objectives. One of ordinary skill in the art will appreciate that the multipurpose extension cord system 100 as shown in the FIGS. 1-3 are for illustrative purposes only, and that many other sizes and shapes of the multipurpose extension cord system 100 are well within the scope of the present disclosure. Although the dimensions of the multipurpose extension cord system 100 are important design parameters for user convenience, the multipurpose extension cord system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A power transfer extension cord system comprising:
a transfer extension power cord having a main wire including an insulating layer wrapped therearound;
wherein said main wire having three split wires;
wherein said split wires including a first split hot wire, a second split neutral wire, and a third split ground wire;
wherein said main wire having a first end and an opposing second end;
wherein at said first end said first split hot wire having two hot wire electrical clips for clipping to a hot bar of a main breaker box, said second split neutral wire having a neutral electrical clip for clipping to a neutral bar of the main breaker box, and said third split ground wire having a ground electrical clip for clipping to a ground bar of the main breaker box; and
further wherein at said second end said main wire connected to a three-prong plug.

2. The power transfer extension cord of claim 1, wherein said two hot wire electrical clips, said neutral electrical clip, and said ground electrical clip are alligator clips.

3. The power transfer extension cord of claim 2, wherein said first split hot wire having a first color.

4. The power transfer extension cord of claim 3, wherein said second split neutral wire having a second color.

5. The power transfer extension cord of claim 4, wherein said third split ground wire having a third color.

6. The power transfer extension cord of claim 5, wherein said two hot wire electrical clips, said neutral electrical clip, and said ground electrical clip having a material selected from the group consisting of a copper and a nickel-plated steel.

7. The power transfer extension cord of claim 6, wherein said first split hot wire, said second split neutral wire, and said third split ground wire having a material selected from the group consisting of a copper, an aluminum, and a steel.

8. The power transfer extension cord of claim 7, wherein said first split hot wire, said second split neutral wire, and said third split ground wire having a gauge selected from the group consisting of 12 gauge, a 14 gauge, and a 16 gauge.

9. A power transfer extension cord system comprising:
a transfer extension power cord having a main wire including an insulating layer wrapped therearound;
wherein said main wire having three split wires;
wherein said split wires including a first split hot wire, a second split neutral wire, and a third split ground wire;
wherein said main wire having a first end and an opposing second end;
wherein at said first end said first split hot wire having two hot wire electrical clips for clipping to a hot bar of a main breaker box, said second split neutral wire having a neutral electrical clip for clipping to a neutral bar of the main breaker box, and said third split ground wire having a ground electrical clip for clipping to a ground bar of the main breaker box;
wherein at said second end said main wire connected to a three-prong plug; and
further wherein said two hot wire electrical clips are clipped to the hot bar of the main braker box, said neutral electrical clip is clipped to the neutral bar of the main breaker box, said ground electrical clip is clipped to the ground bar of the main breaker box, and said three-prong plug plugged into a generator for providing electrical power from the main breaker box to the generator.

10. The power transfer extension cord of claim 9, wherein said two hot wire electrical clips, said neutral electrical clip, and said ground electrical clip are alligator clips.

11. The power transfer extension cord of claim 9, wherein said first split hot wire having a first color.

12. The power transfer extension cord of claim 11, wherein said second split neutral wire having a second color.

13. The power transfer extension cord of claim 12, wherein said third split ground wire having a third color.

14. The power transfer extension cord of claim 13, wherein said two hot wire electrical clips, said neutral electrical clip, and said ground electrical clip having a material selected from the group consisting of a copper and a nickel-plated steel.

15. The power transfer extension cord of claim 14, wherein said first split hot wire, said second split neutral wire, and said third split ground wire having a material selected from the group consisting of a copper, an aluminum, and a steel.

16. The power transfer extension cord of claim 15, wherein said first split hot wire, said second split neutral wire, and said third split ground wire having a gauge selected from the group consisting of 12 gauge, a 14 gauge, and a 16 gauge.

17. A power transfer extension cord system comprising:
a transfer extension power cord having a main wire including an insulating layer wrapped therearound;
wherein said main wire having at least three split wires;
wherein said at least three split wires including a first split hot wire, a second split neutral wire, and a third split ground wire;
wherein said main wire having a first end and an opposing second end;
wherein at said first end said first split hot wire having two hot wire alligator clips for clipping to a hot bar of a main breaker box, said second split neutral wire having a neutral alligator clip for clipping to a neutral bar of the main breaker box, and said third split ground wire having a ground alligator clip for clipping to a ground bar of the main breaker box;
wherein at said second end said main wire connected to a three-prong plug; and
further wherein said two hot wire alligator clips are clipped to a female receiver of the hot bar of the main braker box, said neutral alligator clip is clipped to a female receiver of the neutral bar of the main breaker box, said ground alligator clip is clipped to a female receiver of the ground bar of the main breaker box, and said three-prong plug plugged into a generator for providing electrical power from the main breaker box to the generator.

18. The power transfer extension cord of claim 17, wherein said two hot wire electrical clips, said neutral electrical clip, and said ground electrical clip having a material selected from the group consisting of a copper and a nickel-plated steel.

19. The power transfer extension cord of claim 18, wherein said first split hot wire, said second split neutral wire, and said third split ground wire having a material selected from the group consisting of a copper, an aluminum, and a steel.

20. The power transfer extension cord of claim 19, wherein said first split hot wire, said second split neutral wire, and said third split ground wire having a gauge selected from the group consisting of 12 gauge, a 14 gauge, and a 16 gauge.
